(19) United States
(12) Patent Application Publication
(10) Pub. No.: US 2010/0067800 A1
(43) Pub. Date: Mar. 18, 2010

(54) MULTI-CLASS TRANSFORM FOR DISCRIMINANT SUBSPACE ANALYSIS

(75) Inventors: Zhouchen Lin, Beijing (CN); Wenming Zheng, Nanjing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/212,572

(22) Filed: Sep. 17, 2008

(51) Int. Cl. G06K 9/46

(52) U.S. Cl. 382/190

(57) ABSTRACT

A multi-class discriminant subspace analysis technique is described that improves the discriminant power of Linear Discriminant Analysis (LDA). In one embodiment of the multi-class discriminant subspace analysis technique, multi-class feature selection occurs as follows. A data set containing multiple classes of features is input. Discriminative information for the data set is determined from the differences of class means and the differences in class scatter matrices by computing an optimal orthogonal matrix that approximately simultaneously diagonalizes autocorrelation matrices for all classes in the data set. The discriminative information is used to extract features for different classes of features from the data set.

### BACKGROUND

Feature extraction plays a key role in statistical pattern recognition and image processing. When the data input to an algorithm is very large and contains much redundant information, the input data is reduced to a set of features, or a feature vectors, that represents the data. Transforming the input data into the set of features is called feature extraction. The feature set extracts the relevant information from the input data in order to perform the desired task using this reduced representation instead of the full size input.

Principal component analysis (PCA) and Fisher linear discriminant analysis (LDA) are two very popular linear feature extraction techniques. PCA is an unsupervised method that aims at preserving the global structure of the data set by seeking projection vectors that maximize the variances of the data samples. LDA, on the other hand, is a supervised feature extraction method, which aims to seek discriminant vectors that maximize the ratio between between-class scatter and within-class scatter. (Within-class scatter is a measure of the scatter of a class relative to its own mean. Between-class scatter is a measure of the distance from the mean of each class to the mean(s) of the other classes.) Both PCA and LDA have been widely used in many applications. However, LDA will fail when the mean vectors of classes are nearly identical.

The Fukunaga-Koontz Transform (FKT) is another widely used feature extraction method, which was originally proposed by Fukunaga and Koontz for two-class feature selection. The basic idea of this method is to find a set of vectors which can simultaneously represent the two classes, in which the basis vectors that best represent one class will be the least representative ones for the other class. This property makes the FKT method very useful for discriminant analysis. During the last several years, the FKT method has been used in many applications, including image classification, face detection, and face recognition. However, to date, the classic FKT method has only been suitable for two class problems, which limits its applications to the more general multi-class problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the multi-class discriminant subspace analysis technique described herein is a new discriminant subspace analysis method that improves the discriminant power of Linear Discriminant Analysis (LDA). In one embodiment, after a global autocorrelation matrix is determined for a data set, the technique best simultaneously diagonalizes (but may not exactly diagonalize) all class autocorrelation matrices of the data set. The technique develops an objective function that formulates a new Multi-class Fukunaga-Koontz transform into an optimization problem of best simultaneously diagonalizing autocorrelation matrices of all classes of a data set. This optimization problem, in one embodiment of the technique, can be solved by a conjugate gradient method on the Stiefel manifold. The technique extracts not only discriminative information from the differences of class means, but also from the differences of class scatter matrices.

More specifically, in one embodiment of the multi-class discriminant subspace analysis technique, multi-class feature selection occurs as follows. A data set containing multiple classes of features is input. Discriminative information for the data set is determined from the differences of class means and the differences in class scatter matrices by computing an optimal orthogonal matrix that approximately simultaneously diagonalizes autocorrelation matrices for all classes in the data set. The discriminative information is used to extract features for different classes of features from the data set.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 is a diagram depicting one exemplary architecture in which one embodiment of the multi-class discriminant subspace analysis technique can be implemented.

FIG. 2 is a flow diagram depicting a generalized exemplary embodiment of a process for employing the multi-class discriminant subspace analysis technique.

FIG. 3 is a flow diagram depicting another exemplary embodiment of a process for employing the multi-class discriminant subspace analysis technique.

FIG. 4 is a flow diagram depicting yet another exemplary embodiment of a process for employing the multi-class discriminant subspace analysis technique.

FIG. 5 is a diagram depicting an example of the best simultaneously diagonalized autocorrelation matrices for a data set.

FIG. 6 is a diagram of three discriminant subspaces of a transformed space.

FIG. 7 is a schematic of an exemplary computing device in which the multi-class discriminant subspace analysis technique can be practiced.

### DETAILED DESCRIPTION

In the following description of the multi-class discriminant subspace analysis technique, reference is made to the accompanying drawings, which form a part thereof, and which is shown by way of illustration examples by which the multi-class discriminant subspace analysis technique may be practiced. It is to be understood that other embodiments may be utilized and structural changes may be made without departing from the scope of the claimed subject matter.

1.0 Multi-Class Discriminant Subspace Analysis Technique.

The multi-class discriminant subspace analysis technique described herein is a new discriminant subspace analysis method that improves the discriminant power of LDA.

1.1 Exemplary Architecture

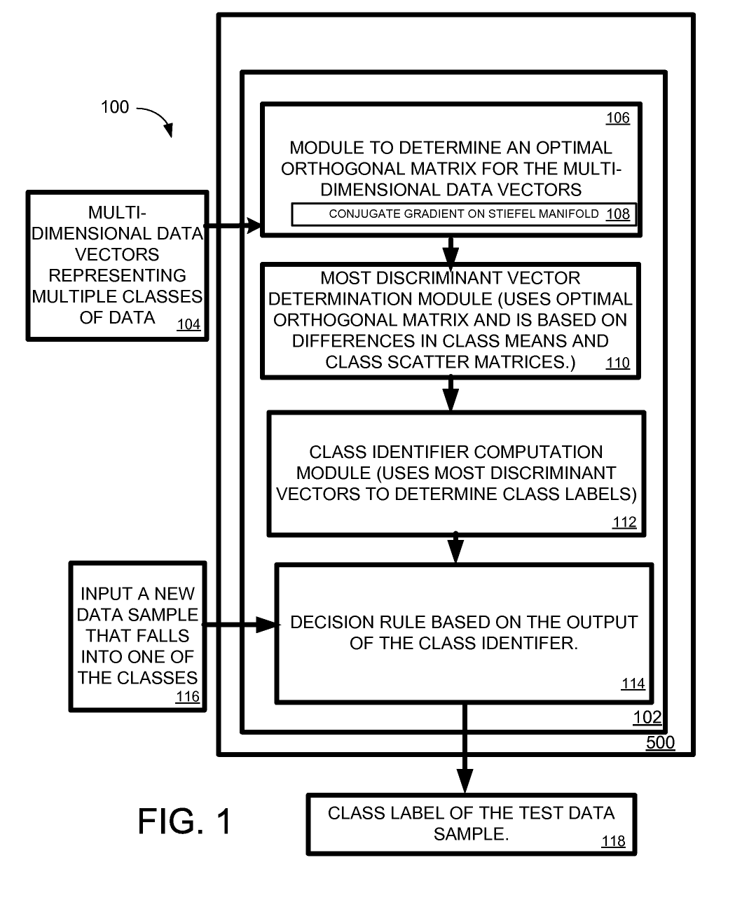

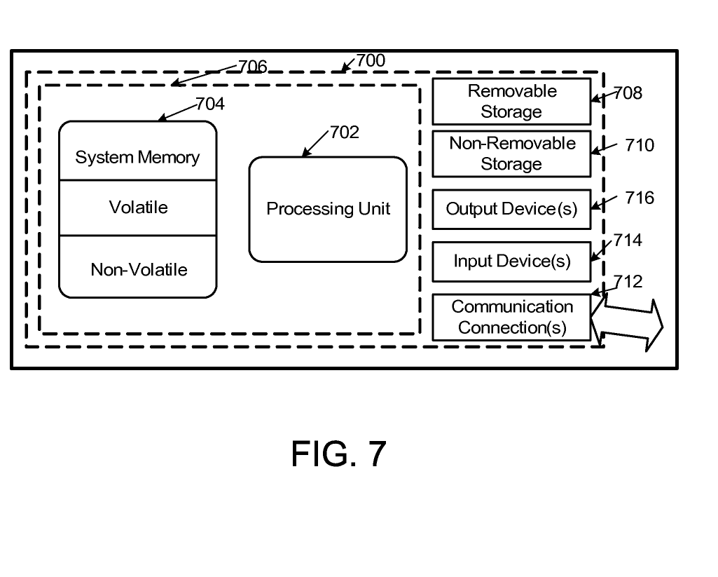

One exemplary architecture 100 in which the multi-class discriminant subspace analysis technique can be implemented is shown in FIG. 1. As shown in FIG. 1, this embodiment of the multi-class discriminant subspace analysis architecture includes a multi-class discriminant subspace analysis module 102 that resides on a computing device 700, such as will be discussed later with respect to FIG. 7. Multi-dimensional data vectors representing multiple classes of data 104 are input. A module 106 finds an optimal orthogonal matrix that best simultaneously diagonalizes the autocorrelation matrices of the input data vectors. In one embodiment this is done by employing a conjugate gradient method on the Stiefel manifold 108. A module that determines the most discriminant vectors for each class by using the optimal orthogonal matrix 110 is employed. A class identifier for each class can then be computed using the most discriminant vectors in module 112. The class identifier for each class can then be used to create a decision rule 114 for extracting features for data containing any of the classes in the multiple classes of data. When a new data sample 116 is input into the decision rule 114, the class features for the classes present in the new data sample 116 are identified and output 118. These extracted features can be useful, for example, in image processing and pattern recognition applications.

1.2 Exemplary Processes Employing the Multi-Class Discriminant Subspace Analysis Technique.

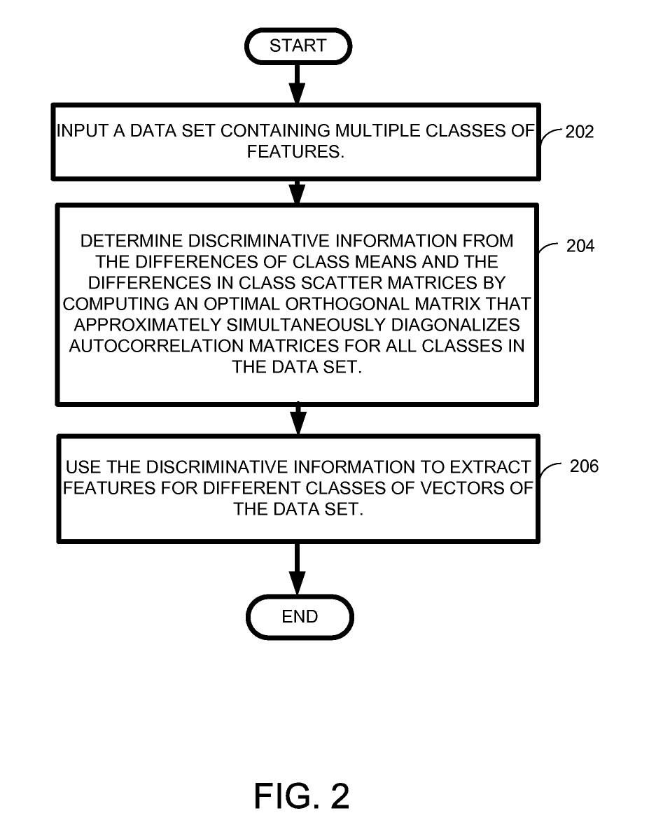

A general exemplary process for employing the multi-class discriminant subspace analysis technique is shown in FIG. 2. In this embodiment of the multi-class discriminant subspace analysis technique, multi-class feature selection occurs as follows. A data set of multi-dimensional data vectors containing multiple classes is input, as shown in block 202. Discriminative information is determined from the differences of class means and the differences in class scatter matrices by computing an optimal orthogonal matrix that approximately simultaneously diagonalizes autocorrelation matrices for all classes in the data set (block 204). The discriminative information is then used to extract features for different classes from the data set, as shown block 206.

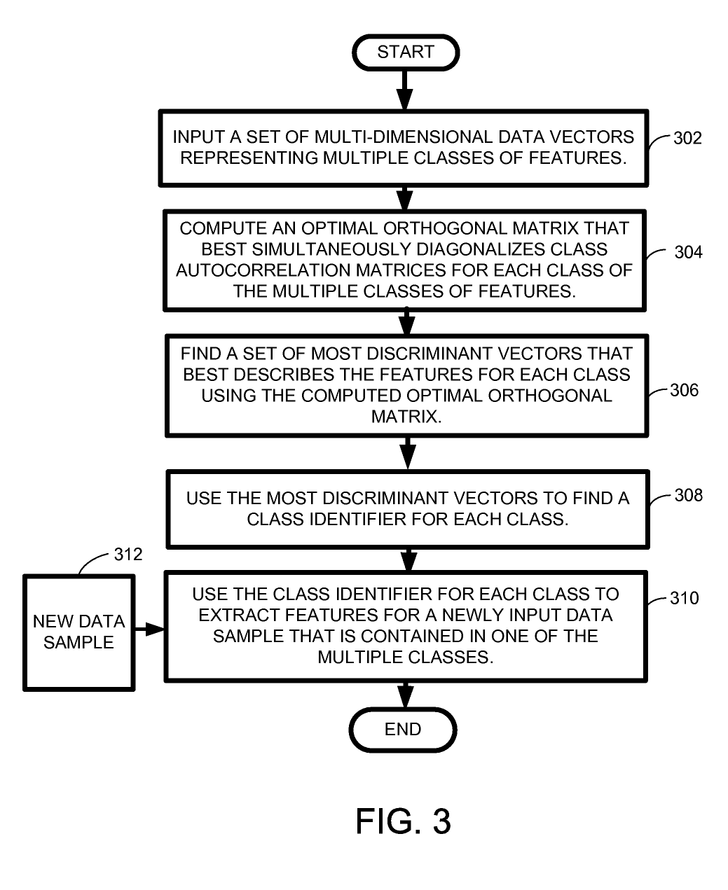

Another exemplary process for employing the multi-class discriminant subspace analysis technique is shown in FIG. 3. Multi-class feature selection occurs as follows. A set of multi-dimensional data vectors representing multiple classes of features is input (block 302). An optimal orthogonal matrix that best simultaneously diagonalizes class autocorrelation matrices for each class of the multiple classes is computed (block 304). A set of most discriminant vectors that best describe the features for each class is then found using the optimal orthogonal matrix (block 306). Once the most discriminant vectors are found they are used to find a class identifier for each class (block 308). These class identifiers can then be used to extract features for each class (blocks 310, 312, 314).

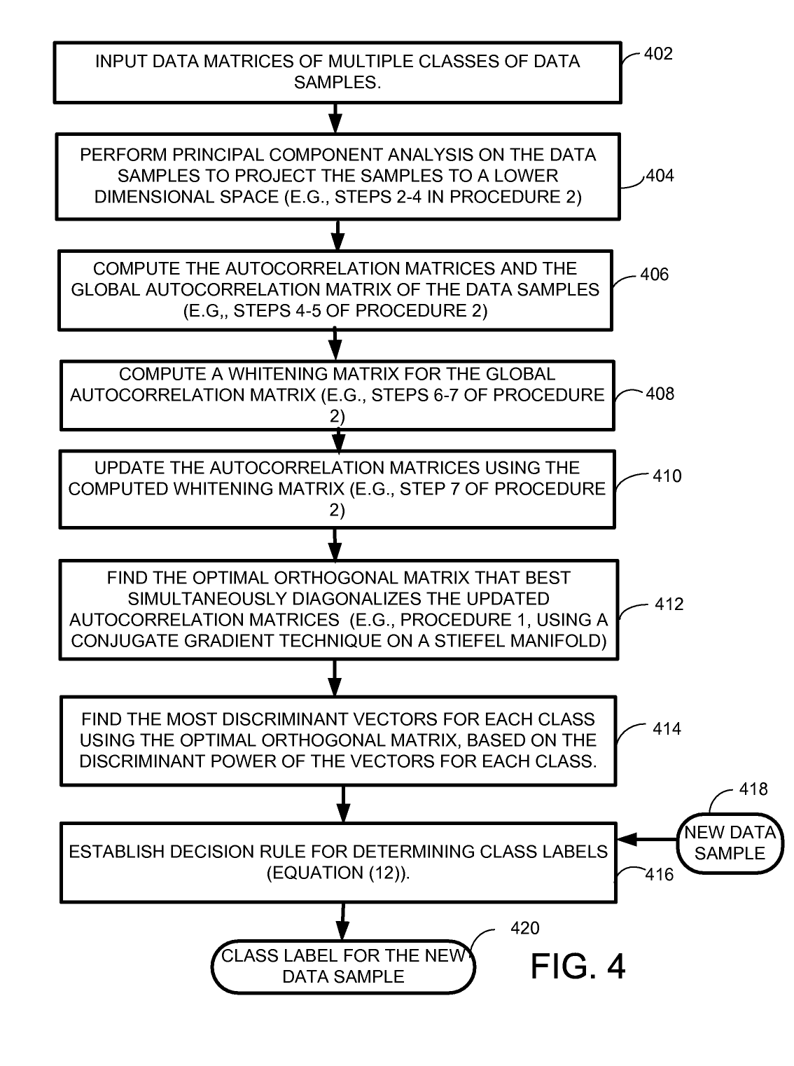

Yet another more detailed exemplary process for employing the multi-class discriminant subspace analysis technique is shown in FIG. 4. Details for this embodiment, including exemplary mathematical computations, will be provided in the next section. In this embodiment, multi-class feature selection occurs as follows. Data matrices of multiple classes are input (block 402). Principal component analysis is performed on the data samples to project the samples to a lower dimensional space, as shown in block 404. Autocorrelation matrices and the global autocorrelation matrix of the projected data samples are then computed (block 406). A whitening matrix is then computed for the global autocorrelation matrix (block 408). The previously computed autocorrelation matrices are then updated using the computed whitening matrix to create updated autocorrelation matrices (block 410). An optimal orthogonal matrix that best simultaneously diagonalizes the new autocorrelation matrices is then computed (block 412). The best discriminant vectors for each class are then found, based on the discriminant power of the vectors for each class, using the optimal orthogonal matrix (block 414). A decision rule can then be established using the best discriminant vectors for each class (block 416). A new data sample can then be input and the decision rule can be applied (block 418). Class labels (e.g., features) for the new data sample can then be obtained (block 420).

It should be noted that many alternative embodiments to the discussed embodiments are possible, and that steps and elements discussed herein may be changed, added, or eliminated, depending on the particular embodiment. These alternative embodiments include alternative steps and alternative elements that may be used, and structural changes that may be made, without departing from the scope of the disclosure.

1.4 Exemplary Embodiments and Details.

Various alternate embodiments of the multi-class discriminant subspace analysis technique can be implemented. The following paragraphs provide details and alternate embodiments of the exemplary architecture and processes presented above.

1.4.1 Brief Review of Classical Two-Class FKT Approach

In order to understand the details of various embodiments of the multi-class discriminant subspace analysis, a brief review of the classical two-class FKT approach is useful. Let X₁ and X₂ be two data matrices, where each column is a d-dimensional vector. Then the autocorrelation matrices of X₁ and X₂ can be expressed as R₁=X₁X₁^{T} and R₂=X₂X₂^{T}, respectively, and the global autocorrelation matrix can be expressed as R=R₁+R₂. Performing the singular value decomposition (SVD) of R, one obtains:

$$R = ( \begin{matrix}V & {V}^{⊥}\end{matrix} ) ( \begin{matrix}Λ & 0 \\ 0 & 0\end{matrix} ) ( \begin{matrix} {V}^{T} \\ {( {V}^{⊥} )}^{T}\end{matrix} ) , \qquad ( 1 )$$

where Λ is a diagonal matrix whose diagonal elements are positive. Let P=VΛ^{-1/2}. Then one obtains:

P^{T}RP=P^{T}(R₁+R₂)P=\hat{R}₁+\hat{R}₂=I,

where \hat{R}₁=P^{T}R₁P, \hat{R}₂=P^{T}R₂P, and I is the identity matrix. Let

\hat{R}₁φ=λ₁φ, (2)

be the eigen-analysis of \hat{R}₁. Then one has:

\hat{R}₂φ=(I−\hat{R}₁)φ=(1−λ₁)φ. (3)

Equations (2) and (3) show that \hat{R}₁ and \hat{R}₂ share the same eigenvectors φ, but the corresponding eigenvalues are different (the eigenvalues of \hat{R}₂ are λ₂=1−λ₁) and they are bounded between 0 and 1. Therefore, the eigenvectors which best represent class 1 (e.g., λ₁≈1) are the poorest ones for representing class 2 (e.g., λ₂=1−λ₁≈0). Suppose the SVD of \hat{R}₁ is \hat{R}₁=Q₁Λ₁Q₁^{T} and \hat{P}=PQ₁, then one obtains that \hat{P}^{T}\hat{R}₁\hat{P}=Λ₁, and \hat{P}^{T}\hat{R}₂\hat{P}=I−Λ₁. So \hat{P} simultaneously diagonalizes R₁ and R₂.

It is notable that the above two-class FKT solution method cannot be simply extended to the general multi-class problem. This is because there may not exist a matrix that exactly diagonalizes all of the autocorrelation matrices of a data set simultaneously. For multi-class problems, Fukunaga suggests using a sequence of pairwise comparisons of likelihood functions, where each pair can be examined using the two-class FKT approach. However, this pairwise FKT approach works in a relative manner, i.e., the eigenvectors representing each class are solved independently, rather than in a unified manner. Therefore, a thresholding method is needed in order to use it.

1.4.2 Multi-Class FKT Approach

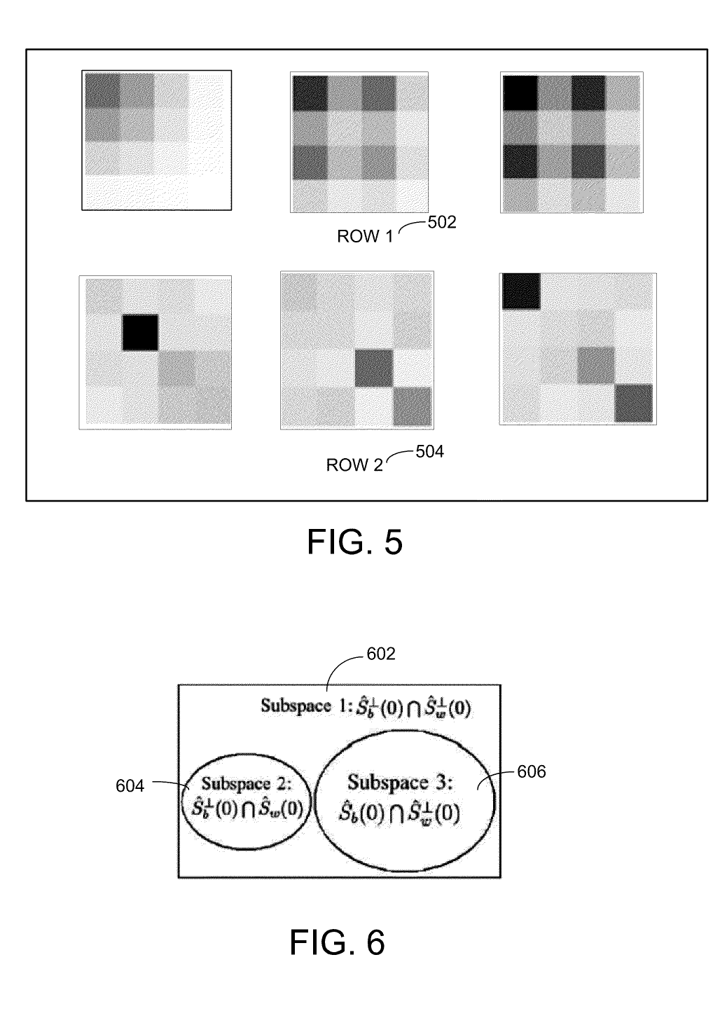

In this section, the multi-class discriminant subspace analysis technique, which seeks to best simultaneously diagonalize all of the class autocorrelation matrices, is described. The concept of best simultaneous diagonalization is illustrated in FIG. 5. The first row 502 depicts three 4×4 class autocorrelation matrices. The second row 504 depicts the results of simultaneous diagonalization after performing the multi-class discriminant subspace analysis technique. The grayscale corresponds to the magnitude of the matrix elements, where the darker pixels indicate larger values.

1.4.2.1 Basic Concept of the Multi-Class Discriminant Subspace Analysis Technique

The following description provides a general description, in mathematical terms, of one embodiment of the multi-class discriminant subspace analysis technique. This description corresponds generally to the flow diagram of FIG. 4 and correspondences are so annotated.

Suppose that one has c classes' data matrices Xᵢ(i=1,2, . . . , c) from a d-dimensional data space. The autocorrelation matrices of Xᵢ can be expressed as Rᵢ=XᵢXᵢ^{T}, and the global autocorrelation matrix is

$$R = {\sum }_{i = 1}^{c} {R}_{i} .$$

Similar to the two-class FKT method, the multi-class discriminant subspace analysis technique performs SVD of R as shown in equation (1) with P=VΛ^{-1/2}. The technique obtains that

$${P}^{T} RP = {P}^{T} ( {R}_{1} + {R}_{2} + … + {R}_{c} ) P = {\sum }_{i = 1}^{c} {\hat{R}}_{i} = I , \\ where {\hat{R}}_{i} = {P}^{T} {R}_{i} P ( i = 1 , 2 , … , c ) . \qquad ( 4 )$$

Different from the two-class FKT approach, an orthogonal matrix that exactly diagonalizes all \hat{R}ᵢ's simultaneously may not exist. So the multi-class discriminant subspace analysis technique, as shown in block 412 of FIG. 4, aims at finding an orthogonal matrix Q which can best simultaneously diagonalize the c matrices \hat{R}ᵢ (i=1,2, . . . ,c). Then PQ will best simultaneously diagonalize all \hat{R}ᵢ's. So the MFKT problem can be formulated as the following optimization problem:

$${Q}_{MFKT} = arg {min}_{{Q}^{T} Q = I} g ( Q ) , \qquad ( 5 )$$

where the objective function g(Q) is defined as:

$$g ( Q ) = \frac{1}{4} {\sum }_{i = 1}^{c} {‖ {Q}^{T} \hat{{R}_{i}} Q - diag ( {Q}^{T} {\hat{R}}_{i} Q ) ‖}_{F}^{2} , \qquad ( 6 )$$

in which each term measures how close Q^{T}\hat{R}ᵢQ is to being diagonal.

1.4.2.2 Solving MFKT by the Conjugate Gradient Method on Stiefel Manifold

As shown in FIG. 4, block 412, in one embodiment of the multi-class discriminant subspace analysis technique, the optimization problem of equation (5) is solved by a conjugate gradient method on the Stiefel manifold (the set of all orthogonal matrices). The pseudo-code for computing the optimal orthogonal matrix in one embodiment of the technique is presented in Procedure 1 below. To apply Procedure 1, the technique solves two sub-problems: first, it computes the derivative of g(Q) with respect to Q; second, it minimizes g(Qₖ(t)) over t, where Qₖ(t) is the geodesic of the Stiefel manifold, starting from Qₖ and being parameterized in t.

For the first sub-problem, the derivative of g(Q) can be found to be:

$$\frac{d g ( Q )}{d Q} = \frac{1}{2} ( {\sum }_{i = 1}^{c} {\hat{R}}_{i}^{2} ) Q - {\sum }_{i = 1}^{c} {\hat{R}}_{i} Q diag ( {Q}^{T} {\hat{R}}_{i} Q ) . \qquad ( 7 )$$

For the second sub-problem, it can be noted that g(Qₖ(t)) is a smooth function of t, hence its minimal point can be found by Newton's iteration method as it must be a zero of

$${f}_{k} ( t ) = \frac{d g ( {Q}_{k} ( t ) )}{d t} .$$

To find the zeros of fₖ(t) by Newton's method, it is desirable to know the derivative of fₖ(t). fₖ(t) and

$$\frac{d {f}_{k} ( t )}{d t}$$

which can be found to be:

$$\begin{matrix}{f}_{k} ( t ) = Tr ( {A}_{k} {\sum }_{i = 1}^{c} {S}_{i , k} ( t ) diag ( {S}_{i , k} ( t ) ) ) , & ( 8 ) \\ and & \\ \frac{d {f}_{k} ( t )}{d t} = Tr ( {A}_{k} {\sum }_{i = 1}^{c} [ \begin{matrix}( \begin{matrix}{( {S}_{i , k} ( t ) {A}_{k} )}^{T} + \\ {S}_{i , k} ( t ) {A}_{k}\end{matrix} ) diag ( {S}_{i , k} ( t ) ) + \\ {S}_{i , k} ( t ) diag ( \begin{matrix}{( {S}_{i , k} ( t ) {A}_{k} )}^{T} + \\ {S}_{i , k} ( t ) {A}_{k}\end{matrix} )\end{matrix} ] ) , & ( 9 )\end{matrix}$$

respectively, where S_{i,k}(t)=Qₖ^{T}(t)\hat{R}ᵢQₖ(t) and Tr(X) and diag(X) are the trace and the diagonal matrix of the matrix X, respectively.
Procedure 1: Exemplary Conjugate Gradient Method for Minimizing Objective Function g(Q) on the Stiefel Manifold
Input: Autocorrelation matrices \hat{R}₁, \hat{R}₂, . . . , \hat{R}_{c} and a threshold ε>0.
Initialization:
1. Choose an orthogonal matrix Q₀;
2. Compute the gradient of an objective function g w.r.t. matrix Q at Q₀;

$${Z}_{0} = \frac{d g}{d Q} {\vert}_{{Q}_{0}} ,$$

and its projection onto the tangent space of the Stiefel manifold at Q₀: G₀=Z₀−Q₀Z₀^{T}Q₀;
3. Set the initial search direction: H₀=−G₀, and its associated direction at Q₀: A₀=Q₀^{T}H₀. Let k=0;
Do while the magnitude of the associated direction is above the threshold: ∥Aₖ∥_{F}>ε
1. Minimize g along the geodesic of the Stiefel manifold starting at Qₖ, parameterized in t, and in a direction determined by Aₖ (The direction of the geodesics is QₖAₖ): minimize g(Qₖ(t)), where Qₖ(t)=QₖM(t) and M(t)=e^{tA}^{ₖ};
2. Set tₖ as the t that minimizes g(Qₖ(t)) and update Q: tₖ=tₘᵢₙ and Qₖ₊₁=Qₖ(tₖ), where

$${t}_{min} = arg {min}_{t} g ( {Q}_{k} ( t ) ) ;$$

3. Compute the gradient of the objective function g w.r.t. matrix Q at Qₖ₊₁:

$${Z}_{k + 1} = \frac{d g}{d Q} {\vert}_{{Q}_{k + 1}} ,$$

and its projection onto the tangent space of the Stiefel manifold at Qₖ₊₁: Gₖ₊₁=Zₖ₊₁−Qₖ₊₁Zₖ₊₁^{T}Qₖ₊₁;
4. Parallel transport tangent vector Hₖ to the point Qₖ₊₁: τ(Hₖ)=HₖM(tₖ);
5. Compute the new search direction: Hₖ₊₁=−Gₖ₊₁+γₖτ(Hₖ), where

$${γ}_{k} = \frac{〈 {G}_{k + 1} - {G}_{k} , {G}_{k + 1} 〉}{〈 {G}_{k} , {G}_{k} 〉}$$

and [symbol] A,B [symbol] =tr(A^{T}B);
6. If k achieves the maximal number of possible conjugate directions: k+1≡0 mod d(d−1)/2, then reset the search direction as Hₖ₊₁=−Gₖ₊₁;
7. Update the corresponding associated direction: Aₖ₊₁=Qₖ^{T}Hₖ₊₁;
8. Update k: k=k+1;
Output:
   Output Qₖ, the approximated optimal orthogonal matrix.
      The optimal orthogonal matrix is then available for subsequent computations used for feature selection (e.g., FIG. 4, blocks 414, 416, 418 and 420).

1.4.2.3. Discriminant Subspace Analysis/Multi-Class Fukunaga Koontz Procedure (MFKT).

In this section, other aspects of one embodiment of the multi-class discriminant subspace analysis technique are described. Let uᵢ denote the mean of the i-th data matrix Xᵢ and Nᵢ denote the number of the columns of Xᵢ (i.e., the number of samples in the i-th class). Then the covariance matrix of the i-th data matrix can be expressed as:

Σᵢ=XᵢXᵢ^{T}−Nᵢuᵢuᵢ^{T}, i=1,2, . . . , c.

Let u denote the global mean of the whole data matrices {Xᵢ} (i=1,2, . . . ,c). Then the between-class scatter matrix S_{b}, the within-class scatter matrix S_{w}, and the total-class scatter matrix Sₜ can be respectively expressed as:

$${S}_{b} = {\sum }_{i = 1}^{c} {N}_{i} ( {u}_{i} - u ) {( {u}_{i} - u )}^{T} , \\ {S}_{w} = {\sum }_{i = 1}^{c} {Σ}_{i} , and$$

$${S}_{t} = {S}_{b} + {S}_{w} .$$

The classic two-class FKT method divides the whole data space into four subspaces, including the null space of Sₜ. However, the null space of Sₜ contains no discriminant information. Therefore, in one embodiment of the technique, the multi-class discriminant subspace analysis technique removes it by transforming the input data into the complementary subspace of the null space of Sₜ. Now let Ŝ_{b}(0) and Ŝ_{w}(0) respectively denote the null space of Ŝ_{b} and Ŝ_{w}, and let Ŝ_{b}^{⊥}(0) and Ŝ_{w}^{⊥}(0) respectively denote the orthogonal complement of Ŝ_{b}(0) and Ŝ_{w}(0). Then the transformed space can be divided into three subspaces: (1) Ŝ_{b}^{⊥}(0)∩Ŝ_{w}^{⊥}(0); (2) Ŝ_{b}^{⊥}(0) ∩Ŝ_{w}(0); and (3) Ŝ_{b}(0)∩Ŝ_{w}^{⊥}(0). FIG. 6 illustrated three discriminant subspaces of the transformed space, Subspace 1, 602, Subspace 2, 604 and Subspace 3, 606. Performing the Single Value Decomposition (SVD) of Sₜ, as related to FIG. 4, block 404 and steps 2 through 4 of Procedure 2 that follows later, one obtains that the total scatter matrix

$${S}_{t} = ( U {U}^{⊥} ) ( \begin{matrix}Λ & 0 \\ 0 & 0\end{matrix} ) ( \begin{matrix}{U}^{T} \\ {( {U}^{⊥} )}^{T}\end{matrix} ) ,$$

where Λ is a diagonal matrix and the columns of U and U^{⊥} are orthonormal. The transformed matrices of S_{b}, S_{w}, and Σᵢ can be respectively expressed as:

Ŝ_{b}=U^{T}S_{b}U, Ŝ_{w}=U^{T}S_{w}U, and \hat{Σ}ᵢ=U^{T}ΣᵢU.

In the transformed space, the classical LDA transform method aims to solve the following optimization problem:

$${W}_{LDA} = arg {max}_{{W}^{T} W - T} Tr \{ {( {W}^{T} {\hat{S}}_{w} W )}^{- 1} ( {W}^{T} {\hat{S}}_{b} W ) \} . \qquad ( 10 )$$

The columns of W_{LDA}, the projection matrix of LDA, in equation (10) are the eigenvectors of the following eigensystem corresponding to the leading eigenvalues:

Ŝ_{b}x=λŜ_{w}x. (11)

If the between-class scatter matrix Ŝ_{w} is singular, one can first use PCA to perform the dimensionality reduction such that it becomes nonsingular (e.g., FIG. 4, block 404).

In the LDA method, one can see from equation (10) that the performance mainly depends on the between-class scatter. However, when the class means are close to each other, the between-class scatter will be small and the LDA method may fail. To compensate the weakness of LDA while at the same time keeping its advantages, one embodiment of the multi-class discriminant subspace analysis technique can extract two kinds of discriminative information. The first kind is the same as that of the LDA method, whose discriminative information mainly comes from the differences of the class means. The second kind of discriminative information mainly comes from the differences of class covariance matrices.

To obtain the second kind of discriminative information (e.g., the differences of the class covariance matrices), the multi-class discriminant subspace analysis technique is applied to the c transformed class matrices \hat{Σ}ᵢ (i=1,2, . . . ,c) and an optimal orthogonal matrix Q_{MFKT} that best simultaneously diagonalizes the matrices

$${\hat{\hat{Σ}}}_{i} = {P}^{T} {\hat{Σ}}_{i} P$$

is found, where P is the whitening matrix of

$${\sum }_{i = 1}^{c} {\hat{Σ}}_{i} = {\hat{S}}_{w} .$$

(This corresponds to blocks 408, 410 and 412 of FIG. 4.) By the philosophy of MKFT, Q_{MFKT} contains the discriminant vectors of all the classes. So the multi-class discriminant subspace analysis technique chooses among the column vectors of Q_{MFKT} to find the most discriminant vectors for each class as shown in FIG. 4, block 414.

To this end, suppose Q_{MFKT}=[q₁,q₂, . . . ,qᵣ], where r is the rank of Ŝ_{w}. Using this relationship, for the i-th class, the technique computes

$${d}_{i , j} = {q}_{j}^{T} {\hat{\hat{Σ}}}_{i} {q}_{j} ( j = 1 , 2 , … , r ) ,$$

which measures the discriminant power of vector qⱼ for class i. So the vectors qᵢ_{₁},qᵢ_{₂}, . . . ,qᵢ_{ₖ} that correspond to the top k largest values of d_{i,j} (j=1,2, . . . ,r) are the most discriminant vectors for class i,

Now let Qᵢ=[qᵢ_{₁},qᵢ_{₂}, . . . ,qᵢ_{ₖ}] (i=1,2, . . . ,c). Given a new sample x, one may find its nearest training samples in the LDA subspace by computing the minimal norm of:

yᵢ^{j}=W_{LDA}^{T}(x−xᵢ^{j}),

where xᵢ^{j} is the j-th sample of the i-th class. One can also find its nearest training sample in the space spanned by the most discriminant vectors, i.e., by computing the minimal norm of

zᵢ^{j}=(I−QᵢQᵢ^{T})P^{T}U^{T}(x−xᵢ^{j}).

Integrating the above two strategies, as shown in FIG. 4, blocks 416, 418, 420, the technique finds the class identifier c*(x) of x in the following manner:

$${c}^{*} ( x ) = arg {min}_{i} [ {min}_{j} ( ( 1 - t ) \frac{{‖ {y}_{i}^{j} ‖}^{2}}{{\sum }_{k = 1}^{c} {‖ {y}_{k}^{j} ‖}^{2}} + t \frac{{‖ {z}_{i}^{j} ‖}^{2}}{{\sum }_{k = 1}^{c} {‖ {z}_{k}^{j} ‖}^{2}} ) ] , \qquad ( 12 )$$

where the normalization is for balancing the two strategies and t ∈[0,1] is the fusion coefficient determining the weight of the two kinds of discriminant information in the decision level.

Finally, the pseudo code for one embodiment of the multi-class discriminant subspace analysis technique, as it relates to FIG. 4, is summarized below.

### Procedure 2: DSA/MFKT Procedure

Input: Data matrices X=[X₁,X₂, . . . ,X_{c}] and a test sample x, where Xᵢ is the matrix whose columns are the vectors in class i.
1. Compute the mean vector uᵢ of Xᵢ (i=1,2, . . . ,c) and the mean vector u of X, i.e., u is the mean of all data samples.
2. Set H_{b} be the matrix of centralized means:
   H_{b}=[\sqrt{N₁}(u₁−u),\sqrt{N₂}(u₂−u), . . . ,\sqrt{N_{c}}(u_{c}−u)], Hₜ be the matrix of centralized data samples: Hₜ=X−ue^{T}, and remove the means from data samples in class i: Xᵢ=Xᵢ−uᵢeᵢ^{T}, where eᵢ and e are Nᵢ and N dimensional all-one vectors, respectively, and Nₜ is the number of samples in class i, and N is the total number of data samples (related to block 404 of FIG. 4):
3. Perform the Singular Value Decomposition (SVD) of Hₜ (related to block 404 of FIG. 4):

$${H}_{t} = ( U {U}^{⊥} ) ( \begin{matrix}Λ & 0 \\ 0 & 0\end{matrix} ) ( \begin{matrix}{V}^{T} \\ {V}^{⊥ T}\end{matrix} ) ;$$

4. Project data samples in class i: Xᵢ=U^{T}Xᵢ; (related to block 406 of FIG. 4)
5. Compute the with-class scatter matrix of projected class i: \hat{Σ}ᵢ=XᵢXᵢ^{T}, and the total within-class matrix:

$${\hat{S}}_{w} = {\sum }_{i = 1}^{c} {\hat{Σ}}_{i} ;$$

(related to block 406 of FIG. 4)
6. Perform the SVD of Ŝ_{w}:

$${S}_{w} = ( {V}_{w} {V}_{w}^{⊥} ) ( \begin{matrix}{Λ}_{w} & 0 \\ 0 & 0\end{matrix} ) ( \begin{matrix}{V}^{T} \\ {V}_{w}^{⊥ T}\end{matrix} )$$

(related to block 408 of FIG. 4)
7. Set

$$P = {V}_{w} {Λ}_{w}^{- \frac{1}{2}}$$

as the whitening matrix of \hat{Σ}ᵢ to whiten \hat{Σ}:

$${\hat{\hat{Σ}}}_{i} = {P}^{T} {\hat{Σ}}_{i} P ( i = 1 , 2 , … , c )$$

(blocks 408 and 410 of FIG. 4);
8. Solve the orthogonal matrix Q_{MFKT} that best simultaneously diagonalize

$${\hat{\hat{Σ}}}_{i} ( i = 1 , 2 , … , c )$$

(e.g., by using Procedure 1) (block 412 of FIG. 4);
9. Find the most discriminant vectors Qᵢ for each class (block 414 of FIG. 4);
10. Find the class identifier c*(x) for x by equation (12) (blocks 416, 418, 420 of FIG. 4).

2.0 The Computing Environment

The multi-class discriminant subspace analysis technique is designed to operate in a computing environment. The following description is intended to provide a brief, general description of a suitable computing environment in which the multi-class discriminant subspace analysis technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular mobile devices, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 7 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 7, an exemplary system for implementing the multi-class discriminant subspace analysis technique includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. Additionally, device 700 may also have additional features/functionality. For example, device 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Device 700 may also contain communications connection(s) 712 that allow the device to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 700 may have various input device(s) 714 such as a keyboard, mouse, pen, camera, touch input device, and so on. Output device(s) 716 such as speakers, a display, a printer, and so on may also be included. All of these devices are well known in the art and need not be discussed at length here.

The multi-class discriminant subspace analysis technique may be described in the general context of computer-executable instructions, such as program modules, being executed by a computing device. Generally, program modules include routines, programs, objects, components, data structures, and so on, that perform particular tasks or implement particular abstract data types. The multi-class discriminant subspace analysis technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for performing multi-class feature selection, comprising:
inputting a set of multi-dimensional data vectors representing multiple classes of features;
computing an optimal orthogonal matrix for all of the multiple classes that best simultaneously diagonalizes class autocorrelation matrices for each class;
finding a set of most discriminant vectors that best describe the features for each class using the optimal orthogonal matrix;
using the most discriminant vectors to find a class identifier for each class; and
using the class identifier for each class to extract features in a feature extraction application.

2. The computer-implemented process of claim 1, further comprising computing the optimal orthogonal matrix using a conjugate gradient method on a Stiefel manifold.

3. The computer-implemented process of claim 2, further comprising minimizing the gradient of an objective function with respect to an orthogonal matrix in order to find the optimal orthogonal matrix.

4. The computer-implemented process of claim 1, further comprising computing a whitening matrix for a global autocorrelation matrix that is used to compute the optimal orthogonal matrix.

5. The computer-implemented process of claim 1, further comprising using the optimal orthogonal matrix for determining discriminative information from the differences of class means of the set of multi-dimensional data vectors representing multiple classes of features.

6. The computer-implemented process of claim 1, further comprising using the optimal orthogonal matrix for determining discriminative information from the differences in class scatter matrices of the set of multi-dimensional data vectors representing multiple classes of features.

7. The computer-implemented process of claim 6, further comprising using the discriminative information to extract features for different classes of features representing multiple classes of features for a newly input data sample.

8. The computer-implemented process of claim 1 wherein the feature extraction application is an image processing application.

9. A system for extracting features in a data set, comprising:
a general purpose computing device;
a computer program comprising program modules executable by the general purpose computing device, wherein the computing device is directed by the program modules of the computer program to,
receive multiple-dimensional data vectors representing multiple classes of data;
determine an optimal orthogonal matrix that best simultaneously diagonalizes the autocorrelation matrices of the multiple-dimensional data vectors using the whitening matrix;
use the optimal orthogonal matrix to determine most discriminant vectors for each class; and
use the most discriminant vectors to determine a class identifier for each class of the multiple classes of data to extract features in a feature extraction application.

10. The system of claim 9 further comprising a module for:
creating a decision rule for identifying classes in a subsequently input multiple-dimensional data vector containing at least some of the multiple classes of data; and
using the decision rule to identify features in subsequently input multiple dimensional data vectors.

11. The system of claim 9 further comprising computing a whitening matrix for a global autocorrelation matrix to compute the optimal orthogonal matrix that best simultaneously diagonalizes the autocorrelation matrices.

12. The system of claim 9 further comprising a module for determining the optimal orthogonal matrix that best simultaneously diagonalizes the autocorrelation matrices by employing a conjugate gradient method.

13. The system of claim 9 further comprising a module for determining the optimal orthogonal matrix that best simultaneously diagonalizes the autocorrelation matrices by employing a conjugate gradient method on a Stiefel manifold.

14. The system of claim 9 wherein the most discriminative vectors are based on differences in class means.

15. The system of claim 14 wherein the most discriminative vectors are based on differences in class scatter matrices.

16. A computer-implemented process for extracting features in a data set, comprising:
inputting a data set representing multiple classes of vectors;
determining discriminative information from the differences of class means and the differences in class scatter matrices by computing an optimal orthogonal matrix that approximately simultaneously diagonalizes autocorrelation matrices for all classes in the data set; and
using the discriminative information to extract features for different classes of features of a new data set.

17. The computer-implemented process of claim 16 further comprising computing the optimal orthogonal matrix by employing a conjugate gradient method on a Stiefel manifold.

18. The computer-implemented process of claim 16 wherein the discriminative information is weighted to assign different weights to discriminative information from the differences of class means and the differences in class scatter matrices.

19. The computer-implemented process of claim 16 further comprising transforming the input data set into a complementary subspace of the null space of a total scatter matrix of the input data.

20. The computer-implemented process of claim 16 further comprising reducing the dimensionality of the input data set by applying a principal component analysis procedure.
